(19) United States
(12) Patent Application Publication
(10) Pub. No.: US 2005/0253399 A1
(43) Pub. Date: Nov. 17, 2005

(54) Lock device for glove compartment

(75) Inventors: Yasuo Yamamoto, Yokohama-shi (JP); Yousuke Yanagita, Utsunomiya-shi (JP)

Correspondence Address: HAUPTMAN KANESAKA BERNER PATENT AGENTS, SUITE 300, 1700 DIAGONAL RD, ALEXANDRIA, VA, 22314-2848, US

(73) Assignee: NIFCO INC., Yokohama (JP)

(21) Appl. No.: 11/117,450

(22) Filed: Apr. 29, 2005

(30) Foreign Application Priority Data
May 12, 2004 (JP) 2004-141937

(51) Int. Cl. E05C 3/06

(52) U.S. Cl. 292/201

(57) ABSTRACT

A lock device for a glove compartment includes a lid body for covering the glove compartment, and a latch mechanism attached to the lid body and having an operating member for actuating the latch mechanism. The operating member has a first member passing through a hole of the lid body and operationally attached to the latch mechanism, and a second member fixed to the first member and having a size at least equal to that of the hole. An escape-preventing device is disposed between the first member and the second member for connecting the same. The escape-preventing device includes a raised part formed on the first or second member, and a recessed part for elasticity engaging the raised part formed on the second or first member.

### BACKGROUND OF THE INVENTION AND RELATED ART STATEMENT

The present invention relates to a lock device for holding a lid body of a glove compartment provided in a dashboard in a locked state.

It is common that a glove compartment for storing small objects and the like is provided in an automobile dashboard on a passenger seat side. A glove compartment includes a sub-assembled structure having a rotating latch capable of coupling with a striker made of a bar-shaped material formed in a bracket shape; a slider for holding the coupling state between the rotating latch and the striker; a base for supporting the slider to be capable of sliding; and an operating member for applying a force to the slider to release the coupling between the striker and the rotating latch. The sub-assembled latch mechanism is fixed inside a hollow lid body (see Patent Document 1).

Patent Document 1: Japanese Utility Model Publication (Kokai) No. 07-16877

In order to attach the latch mechanism sub-assembly inside the hollow-constituted lid body, it is necessary to expose the operating handle part for causing the slider to move toward the direction of releasing the coupling between the striker and the rotating latch on an outer surface of the lid body. Accordingly, it is necessary to provide a hole in an outer panel of the lid body for allowing the operating handle part to pass therethrough. When the hole is provided, an interior of the lid body becomes visible through a gap between the operating handle part and the pass-through hole, thereby impairing an appearance. Accordingly, it is necessary to close the gap, thereby making it difficult to install the operating handle part.

In view of the problems described above, an object of the present invention is to provide a lock device for holding a lid body of a glove compartment with good appearance.

Further objects and advantages of the invention will be apparent from the following description of the invention.

### SUMMARY OF THE INVENTION

In order to attain the objects described above, according to the present invention, a lock device includes a latch mechanism sub-assembly attached inside a hollow lid body. It is possible to easily attach an operating handle of a slider without impairing an appearance. The operating handle is includes a first member having one end rotatably attached to a base for supporting the slider to be slidable, and a second member connected to the first member. An escape-preventing device comprising a raised part and a recessed part elastically connected with each other is provided between the first and second members. The lid body is provided with a hole for inserting the first member, and the second member has an outer contour with a size larger than or equal to a contour of the hole.

In the present invention, the first member for driving the slider and the second member exposed outside the lid body so that the passenger can operate are formed as separate members. After the sub-assembled latch mechanism is installed inside the lid body, the second member is easily connected to the first member projecting through the hole provided in the lid body. The second member blocks a gap between the first member and the hole for inserting the first member. Accordingly, it is possible to install the operation member while attaining good appearance.

### BRIEF DESCRIPTION OF THE DRAWINGS

FIG. 1 is an exploded perspective view showing a glove compartment according to the present invention;

FIG. 2 is a horizontal sectional view of a connecting portion of a latch mechanism;

FIG. 3 is a sectional view of the open lever taken along line 3-3 in FIG. 2; and

FIG. 4 is a front view of a driving part.

### DETAILED DESCRIPTION OF PREFERRED EMBODIMENTS

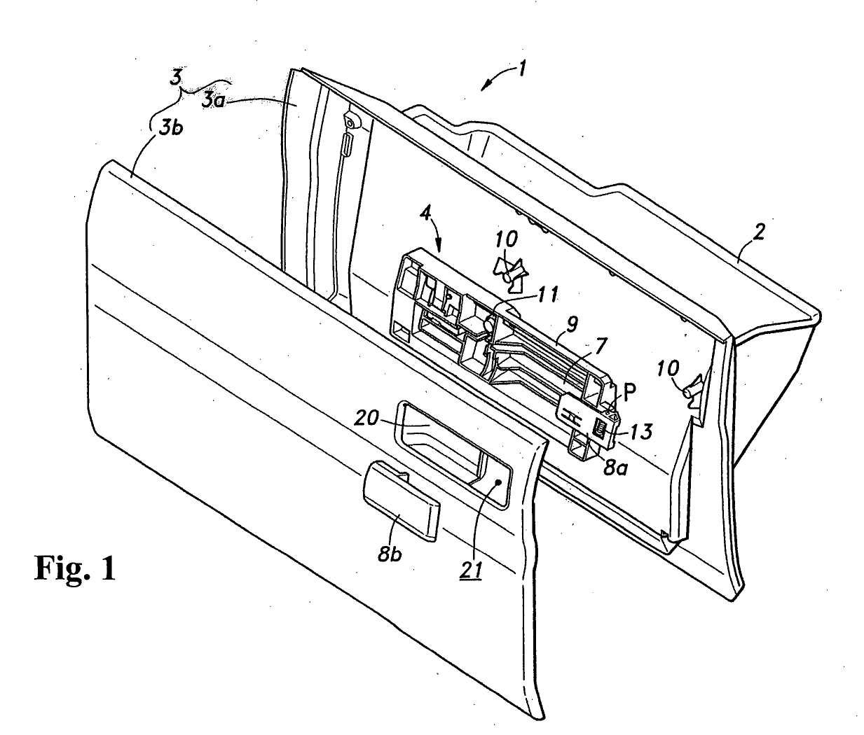

Hereunder, embodiments of the present invention will be explained in detail with reference to the attached drawings. FIG. 1 is an exploded perspective view showing a glove compartment according to the present invention. A glove compartment 1 is provided in a lower surface of a dashboard facing a passenger seat. The glove compartment 1 includes an article housing 2 housed inside a dashboard (not shown), and a lid body 3 for closing an opening provided in the dashboard. The glove compartment 1 is supported on the dashboard such that an upper side of the lid body 3 is drawn forward around a horizontal hinge shaft (not shown) provided on a lower part of the article housing 2.

The lid body 3 comprises an inner panel 3a integrally formed with the article housing 2, and an outer panel 3b joined to a surface of the inner panel 3a on a side of the vehicle compartment. The lid body 3 is constituted such that a space is formed between the inner panel 3a and the outer panel 3b. A latch mechanism 4 is housed inside the space for holding the lid body 3 in the locked state.

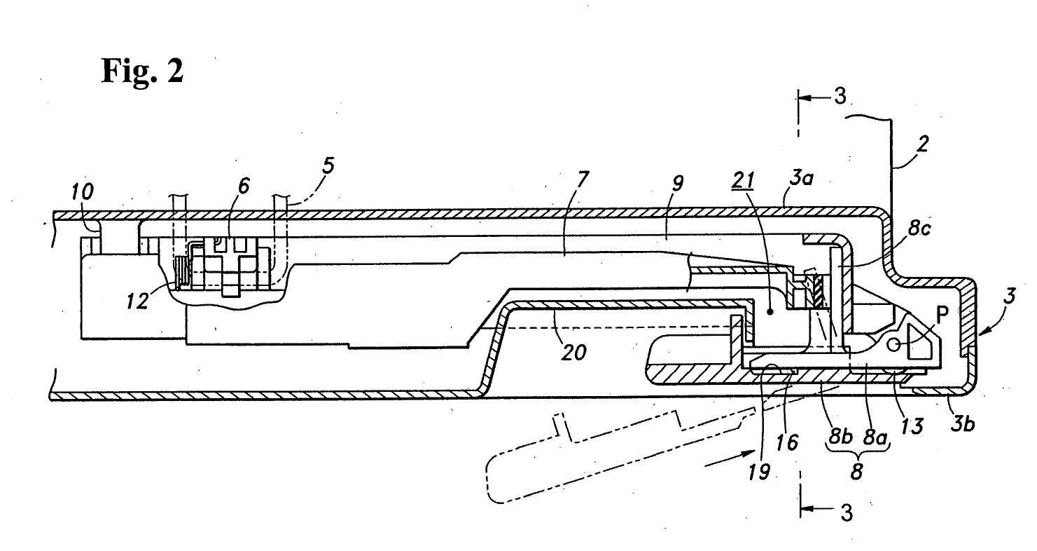

As shown in FIG. 2, the latch mechanism 4 is a sub-assembled structure having a base 9. In the base 9, there are assembled a rotating latch 6 capable of coupling with a striker 5 formed of a bar-shaped material curved into a bracket shape and fixed to the dashboard; a slider 7 for holding the rotating latch 6 in the state coupled with the striker 5; and a driving part 8a of an open lever for applying a force to the slider 7 in a direction that the coupling between the striker 5 is released from the rotating latch 6. The latch mechanism 4 is fixed with tapping screws fitted in a plurality of box parts 10 provided at suitable places of the inner panel 3a.

The slider 7 is supported on the base 9 to be capable of sliding in a lateral direction. The slider 7 is urged by a torsion coil spring 11 attached to an intermediate part of the base 9 toward a position to prevent the rotating latch 6 from rotating. The rotating latch 6 is urged by a torsion coil spring 12 in the direction of releasing the coupling with the striker 5. The latch mechanism 4 is a known mechanism (for example, Japanese Patent Publication (Kokai) No. 2001-271547), and detailed explanation is omitted. The disclosure of the Publication No. 2001-271547 is incorporated herein.

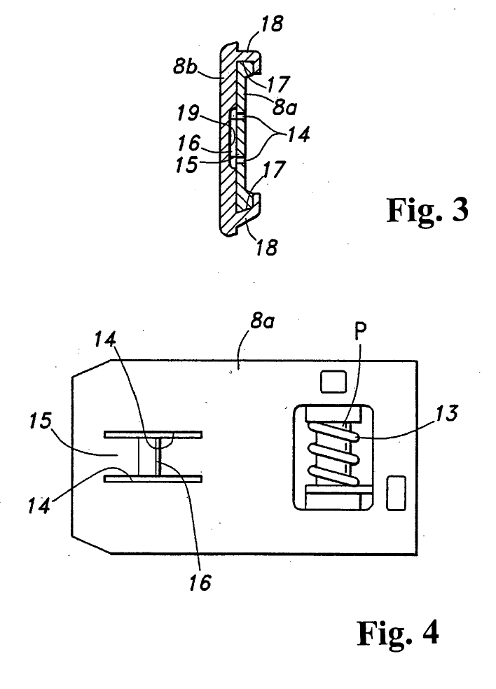

As shown in FIGS. 3 and 4, the open lever 8 is formed of two members, i.e., a driving part 8a with a flat plate shape and an operating part 8b. The driving part 8a is attached to a right end part of the base 9 with a vertical pin shaft P, and is normally urged toward one side by a torsion coil spring 13 wound on the pin shaft P. The operating part 8b is to be connected to the driving part 8a from outside the outer panel 3b after the sub-assembled latch mechanism 4 is fixed to the inner panel 3a and the outer panel 3b is connected to a front surface thereof.

On a free end side of the driving part 8a, there is formed an elastically deformable part 15 with a pair of horizontal slits 14 for easily bending. A raised part 16 having a saw tooth section is formed on an outer surface thereof. A lever 8c projects from an inner surface of the driving part 8a to face a right end of the slider 7. When the driving part 8a is tilted, the free end of the lever 8c pushes the right end of the slider 7 to displace the slider 7 toward the left side and release the rotating latch 6.

On an inner surface of the operating part 8b, a pair of horizontal raised lines 18 having an L-shape section protrudes to form a coupling groove 17 for fitting upper and lower edges of the flat plate-shaped driving part 8a. A recessed part 19 is formed in the inner surface between the pair of raised lines 18 for engaging the raised part 16 of the elastically deformable part 15.

A portion of the outer panel 3b corresponding to the open lever is recessed from a front surface of the outer panel 3b, so that the front surface of the open lever 8 is flush with the outer panel 3b, and a fingertip is hooked to tilt the open lever 8. A part of a bottom of the recessed portion 20 is cut to form a hole 21 having a size just for inserting the driving part 8a.

When the operating part 8b is attached to the driving part 8a of the lever 8 installed in the lid body 3, the driving part 8a is tilted similar to an operation that the rotating latch 6 is released. The free end of the driving part 8a is inserted into the coupling groove 17 formed of the pair of raised lines 18 on the operating part 8b. In this state, the operating part 8b is pushed until the raised part 16 on the front surface of the driving part 8a engages the recessed part 19 in a back surface of the operating part 8b. Accordingly, the raised part 16 with a saw tooth shape engages an edge of the recessed part 19 and is prevented from escaping. When the operating part 8b is attached to the driving part 8a, it is difficult to easily separate the two members.

As described above, it is possible to attach the operating part 8b to the driving part 8a with one touch operation. The operating part 8b has a size larger than that of the driving part 8a for operability, and is attached to the driving part 8a visible at the front side through the pass-through hole 21. Accordingly, the operating part 8b blocks the gap between the driving part 8a and the pass-through hole 21, thereby obtaining good appearance.

The disclosure of Japanese Patent Application No. 2004-141937, filed on May 12, 2004, is incorporated in the application.

While the invention has been explained with reference to the specific embodiments and the invention, the explanation is illustrative and the invention is limited only by the appended claims.

1. A lock device for a glove compartment, comprising:
a lid body for covering the glove compartment and having a hole therein,
a latch mechanism attached to the lid body, and including an operating member for actuating the latch mechanism, said operating member having a first member passing through the hole and operationally attached to the latch mechanism, and a second member fixed to the first member and having a size at least equal to that of the hole, and
an escape-preventing device disposed between the first member and the second member for connecting the same, said escape-preventing device including a raised part formed on one of the first and second members, and a recessed part for elasticity engaging the raised part formed on the other of the first and second members.

2. A lock device according to claim 1, wherein said latch mechanism includes a rotating latch adapted to engage a striker formed on the glove compartment, a slider for holding the rotating latch in a state that the rotating latch engages the striker, and a base for slidably supporting the slider, said rotating latch, slider and base being assembled as a sub-assembly together with the operating member.

3. A lock device according to claim 2, wherein said raised part is formed on the first member, and the recessed part is formed on the second member, said raised part being located in the recessed part by engagement of the first and second members.

4. A lock device according to claim 3, wherein said second member further includes coupling grooves for receiving two side edges of the first member.

5. A lock device according to claim 4, wherein said first member is rotatably attached to the base so that when the first member is rotated, the slider mover to rotate the rotating latch to thereby release the striker.

6. A lock device according to claim 5, wherein said sub-assembly is attached to the lid body.
